(19) United States
(12) Patent Application Publication
(10) Pub. No.: US 2011/0279839 A1
(43) Pub. Date: Nov. 17, 2011

(54) SYSTEM AND METHOD FOR PRINTING

(76) Inventor: Thomas J. Walsh, Fall City, WA (US)

(21) Appl. No.: 12/778,630

(22) Filed: May 12, 2010

(51) Int. Cl. G06K 15/02

(52) U.S. Cl. 358/1.11

(57) ABSTRACT

A system and method for arranging and printing characters, words, or other textual information that is typically printed in a series of rows or columns. A first row is printed to be read in a standard fashion, while a second row is printed in the opposite direction, with the direction of reading being in the opposite direction. Likewise, the letters and words in the second row are inverted about a vertical axis. Each successive row is presented in the opposite direction from the preceding row.

### FIELD OF THE INVENTION

This invention relates generally to systems and methods for printing.

### BACKGROUND OF THE INVENTION

Currently, conventional reading materials are printed in a fashion in which the printed matter is printed serially across the page in a manner in which the reader must process it in a first direction along a line of printed matter, then return across the page to pick up the next line and repeat the pattern. For example, and as shown in the prior art illustration of FIG. 1, a standard page 10 of text is printed in English such that lines of text begin at a left margin and the words within the lines of text follow one another in series from the left side of the page to the right side of the page. Once the end of a line is reached, typically at the right margin or right side of the page, the reader's focus must return to the left margin again in order to continue the sentence or to find the first word of the next sentence.

In some printed materials, the printing extends fully across the page, from the left side margin to the right side margin, both of which may be an inch or less from the edge of the page. If the page is very wide at all, it can be difficult to track back from the right side edge at the completion of one line to pick up the beginning of the next line at the left side edge. For this reason, some magazines or other printed materials print the content in multiple narrower columns on a single page. While this can improve the task of finding the next line, it wastes space on the page by inserting intermediate margins between columns. The reader also still must focus back from the right margin to the left margin to begin each new line, and this traversing time slows the reading process because no actual reading of words is accomplished during this path of visual travel.

### SUMMARY OF THE INVENTION

The present invention comprises a system and method for printing information on a page. In general, the preferred method relates to printed information such as sentences composed of individual words that are presented in a logical series. The information is first printed on a medium such as paper by printing the individual words from a starting position (typically on a left side of a page or column when printing in English) and continuing to print them horizontally across the page toward an ending position (typically on the right side of a page or column when printing in English).

After the last word is printed at the ending position, the printing method advances down the page to continue printing along a line or row beneath the line or row that was just printed. Rather than returning to the left side of the page to print the next word in the series, the next word is printed right-to-left, and with the letters inverted about a vertical axis so that they can be read backward. A preferred printing method continues along this pattern, printing one line left to right, followed by the next line right to left, followed by the next line left to right, and so on until all of the printed matter has been printed.

In accordance with some examples of the invention, in certain other languages information is not read in the same left-to-right and top-to-bottom fashion, although it may still be presented in a series of sequential rows or columns in which the printed matter is always read in series in the same direction. In such other languages, the preferred version of the invention continues to reverse the direction of the characters and the direction of the flow of the information printed on the page.

In accordance with other examples of the invention, the information need not be printed in any particular order, but rather is organized so that after it is printed it appears in the order as described and illustrated further below.

In accordance with still further examples of the invention, a preferred system is provided that arranges printable information so that it can be printed in accordance with the concepts described above.

These and other examples of the invention will be described in further detail below.

### BRIEF DESCRIPTION OF THE DRAWINGS

Preferred and alternative examples of the present invention are described in detail below with reference to the following drawings:

FIG. 1 is an illustration of a prior art page containing printed matter in standard English, presented in a left-to-right, top-to-bottom format.

FIG. 2 is an illustration of the same printed matter as presented in FIG. 1, but printed in accordance with a preferred embodiment of the invention.

FIG. 3 is a flow diagram illustrating a preferred method for arranging information to be printed in accordance with the invention.

FIG. 4 is a representation of a preferred system in accordance with the invention.

### DETAILED DESCRIPTION OF THE PREFERRED EMBODIMENT

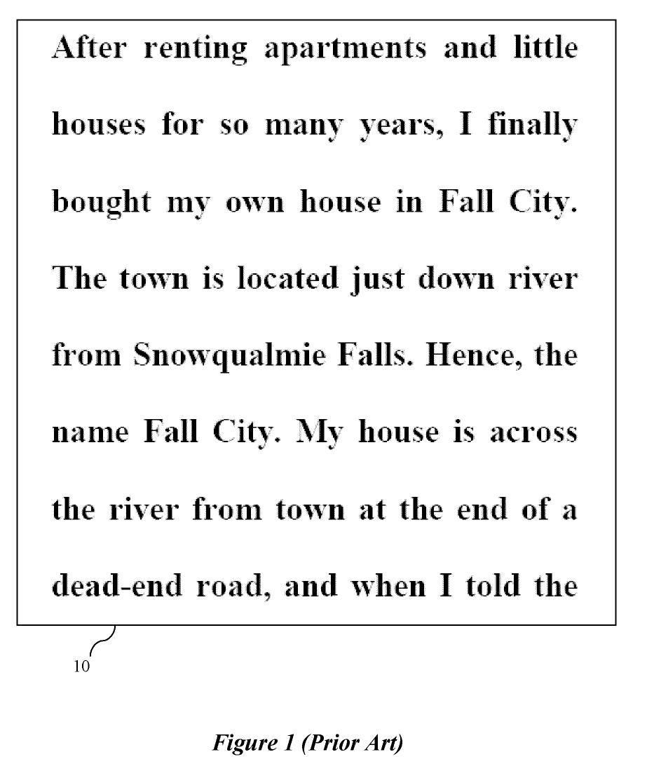

As shown in FIG. 1, standard English is printed so that it appears on a page in a left-to-right and top-to-bottom format. That is, in order to read the content the reader begins at the top-leftmost part of the content and begins reading from that position on the left, across the top row, to the top-rightmost position in the same row. After reading the top row, the reader adjusts focus down to the next row, again starting on the leftmost side of the row of printed information. This process continues for each row, starting at the left side of each row.

The printed information of FIG. 1 is not necessarily printed in the same order in which it is read, though it may be printed in that exact order as in the case of the use of a standard typewriter. More commonly with current printing hardware it is arranged in a desired order on a computer or other such device, then printed after it is arranged. The actual printing may occur in a different pagination order and may print the page from top to bottom, bottom to top, left to right, or some other order. Thus, the description of this invention that refers to printing in a particular order should be understood to mean that the printing process is followed in any particular order that results in the information being printed in the described format.

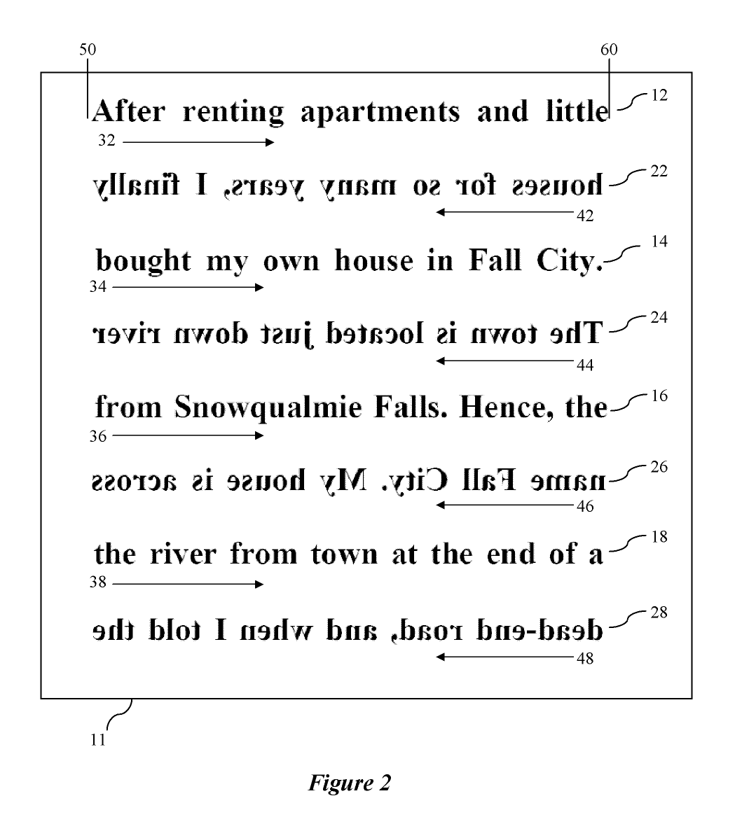

FIG. 2 illustrates the same printed wording of FIG. 1, but presented in accordance with the preferred printing method of the present invention. Thus, FIG. 2 depicts a page 11 having a series of rows of printed English words. The rows extend from a left edge 50 to a right edge 60, with the space between the left and right edges defining the width of the page when the printing fills an entire page, and defining the width of a column when the page is divided into one or more narrower columns.

Across the top of the page, a first row of text 12 is printed such that the text is readable in a first direction represented by a first arrow 32. After reaching the right edge, the next word in a standard printing process would be printed in a next row beneath the first row, and at the left side of the row. In accordance with the illustrated embodiment, the next row of text 22 is presented below the first row of text, but the words are printed such that they are read from right to left, as indicated by a second arrow 42. In addition, each of the words on the page is inverted about a vertical axis (that is, perpendicular to the horizontal axis formed by the row of words) so that the individual words are also backward from standard English and presented in a right to left fashion.

As shown in the illustrated version of FIG. 2, the individual letters forming each word are also inverted about a vertical axis through the center of each letter. Thus, the inverting of the words in this case also inverts each letter at the same time. In other versions of the invention, the words in the second row 22 are spelled in a direction from right to left as indicated by the second row arrow 42, but each of the letters is presented in their standard format without inverting them.

Beneath the second row 22, the third row of text 14 is presented in the same configuration as with the first row, printing the words from left to right in standard English format so that they are readable from right to left as indicated by the arrow 34. The information that follows continues to alternate in this same fashion, such that the even rows 22, 24, 26, 28 are presented from right to left as indicated by arrows 42, 44, 46, 48 and the odd rows of text 12, 14, 16, 18 are presented from left to right as indicated by arrows 32, 34, 36, 38. Additional rows not shown would continue in this same pattern.

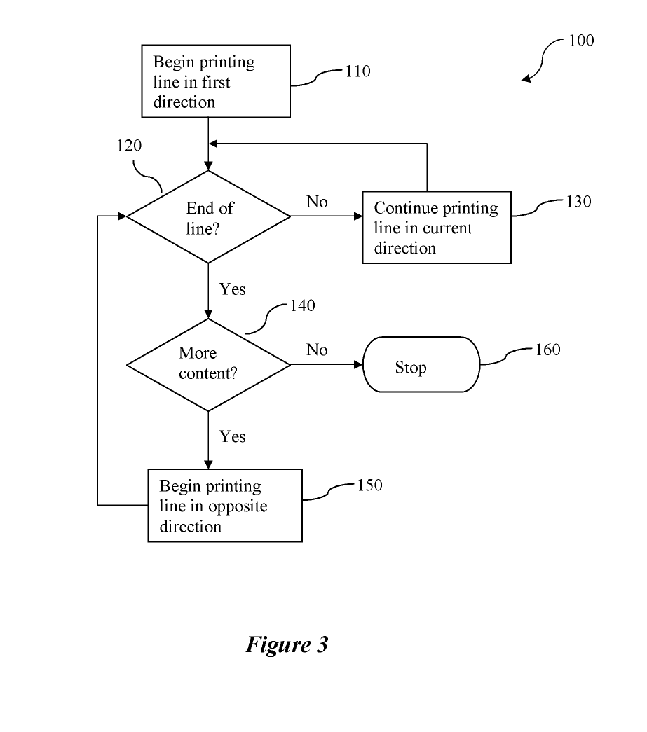

FIG. 3 illustrated a preferred method 100 for arranging and printing text for printing on a page. At a first block 100 the method begins printing a first line in a first direction. This first line would correspond, for example, to the top line of text 12 shown in FIG. 2. It should be appreciated that while FIG. 3 refers to the beginning of “printing” in a first line direction, the method also encompasses an arrangement step in which the method begins by arranging a first line so that it will be printed to be ultimately readable along a line in a first direction.

At a decision block 120 the method asks whether the end of a line has been reached. With respect to the example of FIG. 2, this query asks whether the right edge 60 has been reached when arranging a first line of text, and asks whether the left edge 50 has been reached when arranging a second line of text for printing.

If the end of the line has not been reached, the method continues to a next block 130 in which the method continues printing in the current line and in the current direction (or continues arranging words or characters to be printed so that they are readable along the current line and in the current direction).

If the end of the line has been reached at query block 120, the method continues to a next query block 140 which asks whether there is still more content to be arranged or printed. If the answer is no, the printing or arranging is finished and the method proceeds to a final block 160 where it ends.

If there is more content to print, the method continues to a next block 150 in which it begins printing the next lower line in the direction opposite the preceding line that has just completed (or begins arranging the next lower line so that it will be printed so that it is readable in that manner). This process continues while there is more information to be printed or to be arranged for printing, ending at block 160 when all printable information has been printed or arranged.

When the method is implemented by arranging the content for printing and then printing it, a final step includes printing the information in the manner in which it is arranged. The result of printing the arranged information is to print it on a page in accordance with the example of FIG. 2, in which alternating lines of text are read in opposite directions.

In many instances it may be desirable to begin a new paragraph at the top left margin (when writing in standard English) regardless of the direction of the final line of the previous paragraph. Thus, in one version of the invention each new paragraph begins in a standard left-to-right configuration. In other versions, however, new paragraphs continue the process outlined above.

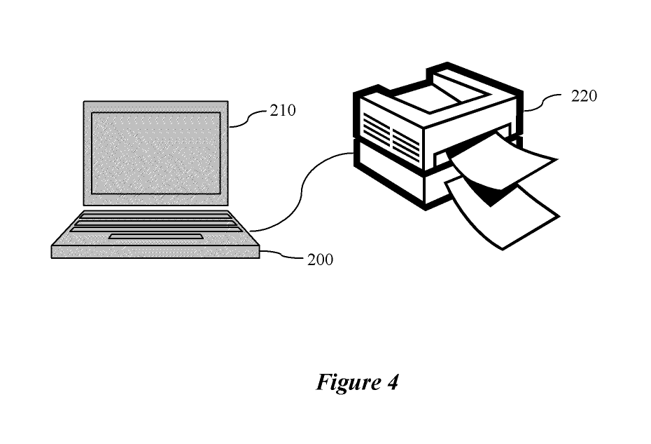

FIG. 4 illustrates a preferred computer system for implementing the method as described above. A computer 200 having a display 210 further includes a keyboard and an internal processor and memory. The memory includes stored programming instructions executable by the processor in order to cause the computer to perform the method of FIG. 3.

The memory may also include programming instructions corresponding to a standard word processing system or other such computer program for accepting text entries from the keyboard. Likewise, it may accept data files that contain information that is printable under the direction of the computer. The programming instructions in accordance with the preferred system may be incorporated into a word processing program or, as yet another alternative, may be a stand-alone process that operates on a text file to arrange it for printing in accordance with the method of FIG. 3. In either case (or other configurations) the computer 200 arranges the text for subsequent printing on a printer 220.

The printer 220 is shown as a standard printer capable of printing text on paper, such as an ink or laser-based printer. The printer may be connected to the computer by a cable, as shown, or may be in wireless communication with the computer. Likewise, the printer may be any device capable of printing under the instruction of the computer, such as a photocopier that accepts computer printing instructions.

In accordance with the method and system as illustrated and described above, preferred versions of the invention arrange and print characters, words, or other textual information that is typically printed in a series of rows or columns. Where the prior art would typically print the rows or columns such that they always start at a common edge (whether it is at the top, bottom, left, or right), the preferred version arranges and prints the content so that a subsequent row (or column) begins along the same edge where the previous row (or column) ends. Thus, when a standard row of text ends at the right edge of the row, the next row of text is arranged and printed so that it also begins at the right edge of the row.

In addition, the flow of text of alternating rows is reversed, so that words in a first row are presented from left to right while words in a second row are presented from right to left. Successive rows are continually alternated with each row being the opposite of the previous row.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A system for printing textual information, the textual information having an initial character, a final character, and a plurality of intermediate characters arranged in progression from the first character to the final character, the system comprising:
a processor;
a display; and
a memory, the memory containing stored programming instructions operable by the processor to cause the processor to:
(i) present a first line from the textual information on the display, the first line being arranged in order and in a first direction from a first edge on the display to a second edge on the display; and
(ii) present a second line from the textual information on the display, the second line being adjacent the first line and continuing from the first line in the arranged progression, the second line being arranged in a second direction from the second edge on the display to the first edge on the display.

2. The system of claim 1, wherein the stored programming instructions cause the processor to present a plurality of additional lines from the textual information on the display, each successive one of the plurality of additional lines continuing to present the textual information sequentially in the arranged progression, the plurality of additional lines comprising a third line and one or more additional odd-numbered lines, and a fourth line and one or more additional even-numbered lines, the third line and the odd numbered lines being arranged in the first direction, the fourth line and the even numbered lines being arranged in the second direction.

3. The system of claim 2, wherein the initial character comprises an initial word.

4. The system of claim 2, further comprising a printer in communication with the processor, the printer being configured to print the textual information presented on the display.

5. A method for presenting textual information, comprising:
presenting the textual information on a tangible medium, the textual information being organized on the tangible medium in a plurality of lines, each of the plurality of lines extending between a first edge and a second edge, the plurality of lines further being adjacent one another and arranged in alternating even-numbered lines and odd-numbered lines, the textual information further being presented sequentially in a first direction from the first edge to the second edge in the odd-numbered lines and continuing sequentially in a second opposite direction from the second edge to the first edge in the even-numbered lines.

6. The method of claim 5, wherein the tangible medium is a computer display.

7. The method of claim 5, wherein the tangible medium comprises paper.

8. The method of claim 7, wherein the step of presenting further comprises printing the textual information on the paper.

9. The method of claim 5, wherein each of the plurality of lines is arranged horizontally between the first edge and the second edge.

10. The method of claim 9, wherein the textual information comprises a plurality of words, each of the words being formed by one or more characters.

11. The method of claim 10, wherein the characters forming the words presented in the odd-numbered lines are arranged sequentially in the first direction, and the characters forming the words presented in the even-numbered lines are arranged sequentially in the second direction.

12. The method of claim 11, wherein the characters forming the words presented in the even numbered lines are rotated about a vertical axis extending through each character.

13. The method of claim 11, wherein the step of presenting the textual information further comprises arranging the textual information and printing the textual information on paper.
